(19) United States
(12) Patent Application Publication
(10) Pub. No.: US 2001/0056343 A1
(43) Pub. Date: Dec. 27, 2001

(54) Sound signal encoding apparatus and method

(76) Inventor: Yoshiaki Takagi, Kanagawa-ken (JP)

Correspondence Address: PEARNE & GORDON LLP, 526 SUPERIOR AVENUE EAST, SUITE 1200, CLEVELAND, OH, 44114-1484, US

(21) Appl. No.: 09/887,613

(22) Filed: Jun. 22, 2001

(30) Foreign Application Priority Data
Jun. 22, 2000 (JP) 2000-188127

(51) Int. Cl. G10L 11/06; G10L 21/00

(52) U.S. Cl. 704/210

(57) ABSTRACT

Herein disclosed is a sound signal encoding apparatus, comprises: sampling means for dividing and sampling a signal inputted therein into a plurality of sound signal sections based on the frequency ranges of the sound signal; each of the sound sections having a pure sound component and a non-pure sound component, and encoding means for encoding the sound signal sections after quantizing the sound signal sections divided and sampled based on the frequency ranges of the sound signal The encoding means comprises a deciding unit for deciding which one in the pure sound component and non-pure sound component is more than the other of the pure sound component and non-pure sound component with respect to each of the sound signal sections divided and sampled based on the frequency ranges of the sound signal; a fast quantizing unit for quantizing only the pure sound component at a first quantization level when the deciding unit is operated to decide that the pure sound component is more than the non-pure sound component with respect to each of the sound signal sections divided and sampled based on the frequency ranges of the sound signal; and a second quantizing unit for quantizing both the pure sound component and the non-pure sound component by way of the predetermined bits of data allocated to both the pure sound component and the non-pure sound component when the deciding unit is operated to decide that the non-pure sound component is more than the pure sound component with respect to each of the sound signal sections divided and sampled based on the frequency ranges of the sound signal sampled based on the frequency ranges of the sound signal.

### BACKGROUND OF THE INVENTION

1. Field of the Invention

The present invention relates to an apparatus for and a method of encoding and transmitting a sound signal, and a computer accessible media for memorizing a sound signal encoding program, and more particularly to an apparatus for and a method of quantizing a sound signal under the optimum condition based on the ratio of the pure component and the non-pure component of the sound signal in every frequency ranges and to a delivery system for delivering sound signal data related to a music.

2. Description of the Related Art

The conventional sound signal encoding apparatus 10 of this type is shown in FIG. 8 as comprising a psycho-acoustic model analyzing unit 1, a filter bank 3, a side module 5, a quantizing unit 7, and a bit stream generating unit 9 to ensure that the sound signal inputted into the psycho-acoustic model analyzing unit 1 is encoded. (see. ISO/IEC 13819-7,11172-3).

The psycho-acoustic model analyzing unit 1 is operative to analyze the inputted sound signal based on the psycho-acoustic model made by taking advantage of a human's heating characteristic to calculate a masking level with respect to the sound signal, The filter bank 3 is operative to sample a plurality of, for example, thirty two sub-bands divided from the inputted sound signal. The side module 5 includes TNS(Temporal Noise Shaping), IS(Intensity Stereo) and MS(Mid/Side Stereo) to enhance an encoding efficiency. The quantization unit 7 is operative to quantize the output signal inputted from the filter bank 3 through the side module 5. The bit stream generator 9 is operative to generate the output digital sound signal in accordance with calculated signal of side-module S and quantization unit 7.

The conventional sound signal encoding apparatus thus constructed in the above encounters such a problem that the sound signal tends to be encoded at a relatively low quality due to the fact that the non-pure sound component is processed as being either encoded or mute without being encoded when the quantization unit is operative to have a non-pure sound component inputted therein under its optimum state with respect to the sound signal having the pure sound component more than the non-pure sound component. Another problem is that there is lack of bit number for encoding, thereby giving rise to a relatively low quality to the encoded sound signal when the quantization unit is operative to have a pure sound component inputted therein under its optimum state with respect to the sound signal having the non-pure sound component more than the pure sound component

### SUMMARY OF THE INVENTION

It is therefore an object of the present invention to overcome the foregoing drawbacks, and to provide an apparatus for and a method of encoding and transmitting a sound signal, and a computer accessible media for memorizing a sound signal encoding program.

It is another object of the present invention to provide a delivery system for delivering sound signal data related to a music at a relatively high quality irrespective of either the pure sound component or non-pure component of the sound signal.

A first aspect of the sound signal encoding apparatus according to the present invention, compass: sampling means for dividing and sampling a signal inputted therein into a plurality of sound signal sections based on the frequency ranges of the sound signal; each of the sound sections having a pure sound component and a non-pure sound component, and encoding means for encoding the sound signal sections after quantizing the sound signal sections divided and sampled based on the frequency ranges of the sound signal, the encoding means comprising: a deciding unit for deciding which one in the pure sound component and non-pure sound component is more than the other of the pure sound component and non-pure sound component with respect to each of the sound signal sections divided and sampled based on the frequency ranges of the sound signal; a first quantizing unit for quantizing only the pure sound component at a first quantization level when the deciding unit is operated to decide that the pure sound component is more than the non-pure sound component with respect to each of the sound signal sections divided and sampled based on the frequency ranges of the sound signal; and a second quantizing unit for quantizing both the pure sound component and the non-pure sound component by way of the predetermined bits of data allocated to both the pure sound component and the non-pure sound component when the deciding unit is operated to decide that the non-pure sound component is more than the pure sound component with respect to each of the sound signal sections divided and sampled based on the frequency ranges of the sound signal sampled based on the frequency ranges of the sound signal.

The sound signal encoding apparats according to present invention thus constructed as previously mentioned can perform the optimum quantization of the sound signal irrespective of the ratio of the pure sound component and the non-pure component contained therein. This means that the sound signal can be encoded at a relatively high quality without being affected by the pure component and non-pure component of the sound signal.

The sound signal encoding apparatus further comprises analyzing means for analyzing the sound signal inputted into the sampling means based on the psycho-acoustic model of human hearing characteristics, the deciding means being operative to decide on the basis of the results analyzed by the analyzing means about which one in the pure sound component and non-pure sound component is more than the other of the pure sound component and non-pare sound component with respect to each of the sound signal sections divided and sampled based on the frequency ranges of the sound signal.

The sound signal encoding apparatus according to present invention thus constructed as previously mentioned can perform the optimum quantization of the sound signal irrespective of the ratio of the pure sound component and the non-pure component contained therein. This means that the sound signal can be encoded at a relatively high quality without beg affected by the pure component and non-pure component of the sound signal.

In the sound signal cording apparatus, the analyzing means is operative to calculate the absolute amount of energy of the pure sound component before analyzing the sound signal inputted into the sampling means based on the absolute amount of energy of the pure sound component.

In the sound signal cording apparatus, the analyzing means is operative to calculate the absolute amount of energy of the non-pure sound component before analyzing the sound signal inputted into the sampling means based on the absolute amount of energy of the non-pure sound component.

In the sound signal cording apparatus, the analyzing means is operative to calculate a difference between the absolute amount of energy of the pure sound component and the absolute amount of energy of the non-pure sound component before analyzing the sound signal inputted into the sampling means based on the difference between the absolute amount of energy of the pure sound component and the absolute amount of energy of the non-pure sound component.

In the sound signal cording apparatus, the analyzing means is operative to calculate the absolute amount of energy of the non-pure sound component and a difference between the absolute amount of energy of the pure sound component and the absolute amount of energy of the non-pure sound component before analyzing the sound signal inputted into the sampling means based on the absolute amount of energy of the non-pure sound component and the difference between the absolute amount of energy of the pure sound component and the absolute amount of energy of the non-pure sound component.

The sound signal delivery system comprises: a sound signal cording apparatus as set forth in the above, a server unit for accumulating the sound signals coded by the sound signal coding apparatus, a plurality of terminal units for requesting the sound signals coded by the sound signal coding apparatus, and a network between the server unit and the terminal units to have the server unit and the terminal units electrically connected to each other, the sever unit being operative to deliver the sound signals coded by the sound signal coding apparatus to the terminal units through the network when the terminal units are operative to request the sever unit to deliver the sound signals coded by the sound signal coding apparatus to the terminal units.

A second aspect of the sound signal encoding method according to the present invention, comprising: sampling step of dividing and sampling a signal inputted into a plurality of sound signal sections based on the frequency ranges of the sound signal; each of the sound sections having a pure sound component and a non-pure sound component, and encoding step of encoding Fe sound signal sections after quantizing the sound signal sections divided and sampled based on the frequency ranges of the sound signal, the encoding step comprising: a deciding step of deciding which one in the pure sound component and non-pure sound component is more than the other of the pure sound component and non-pure sound component with respect to each of the sound signal sections divided and sampled based on the frequency ranges of the sound signal; a first quantizing step of quantizing only the pure sound component at a first quantization level when the deciding unit is operated to decide that the pure sound component is more than the non-pure sound component with respect to each of the sound signal sections divided and sampled based on the frequency ranges of the sound signal; and a second quantizing step of quantizing both the pure sound component and the non-pure sound component by way of the predetermined bits of data allocated to both the pure sound component and the non-pure sound component when the deciding unit is operated to decide that the non-pure sound component is more than the pure sound component with respect to each of the sound signal sections divided and sampled based on the frequency ranges of the sound signal sampled based on the frequency ranges of the sound signal.

The sound signal cording method further comprises an analyzing step of analyzing the sound signal inputted in the sampling step based on the psycho-acoustic model of human auditory organs characteristics, the deciding step being to decide on the basis of the results analyzed in the analyzing step about which one in the pure sound component and non-pure sound component is more than the other of the pure sound component and non-pure sound component with respect to each of the sound signal sections divided and sampled based on the frequency ranges of the sound signal.

In the sound seal cording method, the analyzing step is of calculating the absolute amount of energy of the pure sound component before analyzing the sound signal inputted in the sampling step based on the absolute amount of energy of the pure sound component.

In the sound signal cording method, the analyzing step is of calculating the absolute amount of energy of the non-pure sound component before analyzing the sound signal inputted in the sampling step based on the absolute amount of energy of the non-pure sound component.

In sound signal cording method, the analyzing step is of calculating a difference between the absolute amount of energy of the pure sound component and the absolute amount of energy of the non-pure sound component before analyzing the sound signal inputted in the sampling step based on the difference between the absolute amount of energy of the pure sound component and the absolute amount of energy of the non-pure sound component.

In the sound signal cording method, the analyzing step is of calculating the absolute amount of energy of the non-pure sound component and a difference between the absolute amount of energy of the pure sound component and the absolute amount of energy of the non-pure sound component before analyzing the sound signal inputted in the sampling step based on the absolute amount of energy of the non-pure sound component and the difference between the absolute amount of energy of the pure sound component and the absolute amount of energy of the non-pure sound component.

A third aspect of the recodable media according to the present invention, the recoding media having a sound signal encoding program recorded therein and capable of being recorded by computers, the sound signal encoding program comprises: sampling step of dividing and sampling a signal inputted in a plurality of sound signal sections based on the frequency ranges of the sound signal; each of the sound sections having a pure sound component and a non-pure sound component, and encoding step of encoding the sound signal sections after quantizing the sound signal sections divided and sampled based on the frequency ranges of the sound signal, the encoding step comprising a deciding step of deciding which one in the pure sound component and non-pure sound component is more than the other of the pure sound component and non-pure sound component with respect to each of the sound signal sections divided and sampled based on the frequency ranges of the sound signal; a first quantizing step for quantizing only the pure sound component at a fist quantization level when the deciding unit is operated to decide that the pure sound component is more than the non-pure sound component with respect to each of the sound signal sections divided and sampled based on the frequency ranges of the sound signal; and a second quantizing step for quantizing both the pure sound component and the non-pure sound component by way of the predetermined bits of data allocated to both the pure sound component and the non-pure sound component when the deciding unit is operated to decide that the non-pure sound component is more than the pure sound component with respect to each of the sound signal sections divided and sampled based on the frequency ranges of the sound signal sampled based on the frequency ranges of the sound signal.

The recodable media having a sound signal encoding program recorded therein, further comprises an analyzing step of analyzing the sound signal inputted in the sampling step based on the psycho-acoustic model of human auditory organs characteristics, the deciding step being to decide on the basis of the results analyzed in the analyzing step about which one in the pure sound component and non-pure sound component is more than the other of the pure sound component and non-pure sound component with respect to each of the sound signal sections divided and sampled based on the frequency ranges of the sound signal.

In the recodable media having a sound signal encoding program recorded therein as set forth in claim 15, the analyzing step is of calculating the absolute amount of energy of the pure sound component before analyzing the sound signal inputted in the sampling step based on the absolute amount of energy of the pure sound component.

In the recodable media having a sound signal encoding program recorded therein, the analyzing step is of calculating the absolute amount of energy of the non-pure sound component before analyzing the sound signal inputted in the sampling step based on the absolute amount of energy of the non-pure sound component.

In the recodable media having a sound signal encoding program recorded therein as set forth in claim 15, the analyzing step is of calculating a difference between the absolute amount of energy of the pure sound component and the absolute amount of energy of the non-pure sound component before analyzing the sound signal inputted in the sampling step based on the difference between the absolute amount of energy of the pure sound component and the absolute amount of energy of the non-pure sound component.

In the recodable media having a sound signal encoding program recorded therein, the analyzing step is of calculating the absolute amount of energy of the non-pure sound component and a difference between the absolute amount of energy of the pure sound component and the absolute amount of energy of the non-pure sound component before analyzing the sound signal inputted in the sampling step based on the absolute amount of energy of the non-pure sound component and the difference between the absolute amount of energy of the pure sound component and the absolute amount of energy of the non-pure sound component.

The sound signal encoding apparatus according to present invention thus constructed as previously mentioned can perform the optimum quantization of the sound signal irrespective of the ratio of the pure sound component and the non-pure component contained herein. This means that the sound signal can be encoded at a relatively high quality without being affected by the pure component and non-pure component of the sound signal.

### BRIEF DESCRIPTION OF THE DRAWINGS

The present invention and may of the attendant advantages thereof will be better understood from the following detailed description when considered in connection with die accompanying drawings, wherein:

FIG. 1 is a block diagram of the first embodiment of the sound signal coding apparatus according to the present invention;

FIG. 2 is a block diagram of the second embodiment of the sound signal coding apparatus according to the present invention;

FIG. 3 is a flow chart of the first exemplified process of the sound signal coding apparatus shown in FIG. 2;

FIG. 4 is a flow chart of the second exemplified process of the sound signal coding apparatus shown in FIG. 2;

FIG. 5 is a flow chart of third exemplified process of the sound signal coding apparatus shown in FIG. 2;

FIG. 6 is a flow chart of the fourth exemplified process of the sound signal coding apparatus shown in FIG. 2;

FIG. 7 is a block diagram of the music delivery system according to the present invention; and

FIG. 8 is a block diagram of the conventional sound signal coding apparatus.

### DESCRIPTION OF THE PREFERRED EMBODIMENTS

The embodiments of the encoding apparatus according to the present invention will be described in detail hereinafter. The detailed description will be omitted about the constitutional parts and elements the same as those in all figures bearing the reference numerals the same as those in all figures.

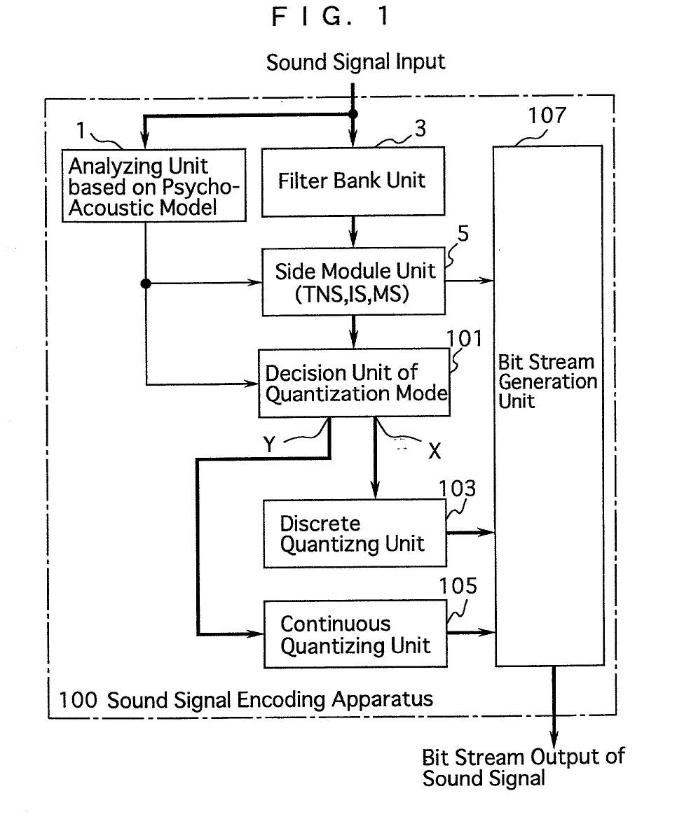

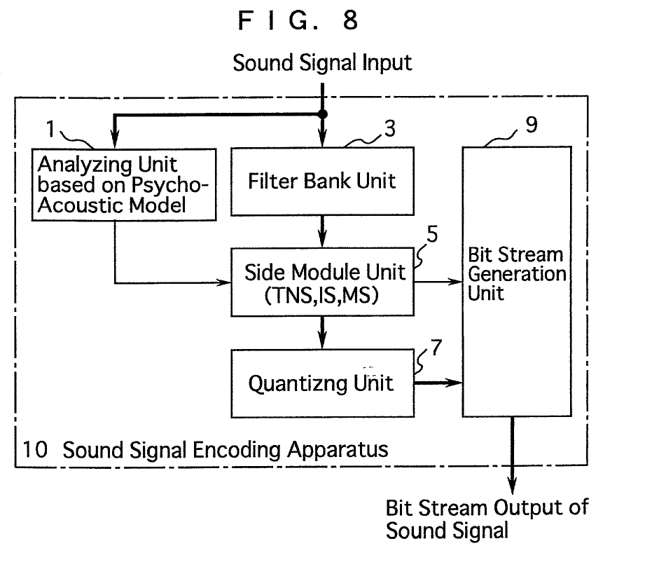

The first embodiment of the sound signal encoding apparatus 100 according to the present invention is shown in FIG. 1 as partly similar in construction to the conventional encoding apparatus 10 shown in FIG. 8 and thus comprises a psycho-acoustic representation analyzing unit 1, a filter bank 3, a side module 5, an a quantization mode deciding unit 101, a discrete quantization unit 103, a continuous quantization unit 105, and a bit stream generation unit 107.

The quantization mode deciding unit 101 is electrically connected to the psycho-acoustic representation analyzing unit 1 and the side module 5 and operative to decide which one in the pure sound component and non-pure sound component is more than the other of the pure sound component and non-pure sound component with respect to each of the sound signal sections divided and sampled based on the frequency ranges of the sound signal. The quantization mode deciding unit 101 has a first output terminal X and a second output terminal Y, and is operative in a first mode to output through the first output terminal X a sound signal inputted from the side module 5 when the pure component is more than the non-pure component in the sound signal and in a second mode to output through the second output terminal Y the sound signal inputted from the side module 5 when the non-pure component is more than the pure component in the sound signal.

The discrete quantization unit 103 is electrically connected to the first output terminal X of the quantization mode deciding unit 101, and is operative to quantize the outputted sound signal from the side module 5 through the quantization mode deciding unit 101, thereby making it possible to optimize the inputted sound signal having the pure component more than the non-pure component when the sound signal is outputted. In the present embodiment of the sound signal encoding apparatus according to the present invention, the discrete quantization unit 103 is designed to quantize only the pure component in the inputted sound signal.

The continuous quantization unit 105 is electrically connected to the second output terminal Y of the quantization mode deciding unit 101, and is operative to quantize the outputted sound signal from the side module 5 through the quantization mode deciding unit 101, thereby making it possible to optimize the inputted sound signal having the non-pure component more than the pure component when the sound signal is outputted. In the present embodiment of the sound signal encoding apparatus according to the present invention, the continuous quantization unit 105 is designed to quantize not only the pure component in the inputted sound signal but also the non-pure component assigned with a quantization bit needed at a minimum level.

The bit stream generation At 107 is electrically connected to the side module 5, the discrete quantization fist 103 and the continuous quantization unit 105, and is operative to generate a bit stream by modulating the output signals from the side module 5, the discrete quantization unit 103 and the continuous quantization unit 105.

The operation of the sound signal encoding apparatus 100 thus constructed will be described hereinafter.

The sound signal is firstly inputted into the psycho-acoustic representation analyzing unit 1 and the filter bank 3. The psycho-acoustic representation analyzing unit 1 is operated to calculate a massing level to be outputted to the side module 5 and the quantization mode deciding unit 101 so that the side module 5 and the quantization mode deciding unit 101 is controlled by the output signal of the psycho-acoustic representation analyzing unit 1. The sound signal inputted into the filter bank 3 is then divided into a plurality of sub-band signal sections based on every predetermined frequency of the sound signal. The divided sub-band signal sections are then inputted into the side module 5 in which various kinds of processing operation are performed to enhance the encoding efficiency of the sound signal encoding apparatus according to the present invention.

The quantization mode deciding unit 101 is operated by the output signals of the psycho-acoustic representation analyzing unit 1 and the side module 5 to decide whether one of the pure component and non-pure component is more than the other of the pure and non-pure component in the sound signal based on every predetermined frequency of the sound signal. When the pure component is decided by the quantization mode deciding unit 101 as being more than the non-pure component in every frequency range of the sound signal, the quantization mode deciding unit 101 is operated to output a sub-band output signal corresponding to the frequency range of the sound signal to the discrete quantization unit 103 through the first output terminal X. When, one the other hand, the non-pure component is decided by the quantization mode deciding unit 101 as being more than the pure component in every frequency Age of the sound signal, the quantization mode deciding unit 101 is operated to output a sub-band output signal corresponding to the frequency range of the sound signal to the continuous quantization unit 105 through the second output terminal Y. The discrete quantization unit 103 is in principle operated to quantize only the pure component in the inputted sound signal while the continuous quantization unit 105 is operated to quantize not only the pure component but also the non-pure component assigned with a quantization bit needed at a minimum level.

The outputted signals from the side module 5, the discrete quantization unit 103 and the continuous quantization unit 105 cause the bit stream generation unit 107 to generate a bit stream by trimming the output signals from the side module 5, the discrete quantization unit 103 and the continuous quantization unit 105.

From the above detailed description, it will be understood that the sound signal can be encoded at a relatively high quality without being affected by the pure component and non-pure component of the sound signal by the reason that the first embodiment of the sound signal encoding apparatus 100 according to the present invention comprises a quantization mode deciding unit 101 for deciding whether one of the pure sound component and non-pure sound component is more than the other of the pure sound component and non-pure sound component, and a discrete quantization unit 103 and a continuous quantization unit 105 both of which are operative to quantize the sound signal under its optimum state based on the decision of the quantization mode deciding unit 101.

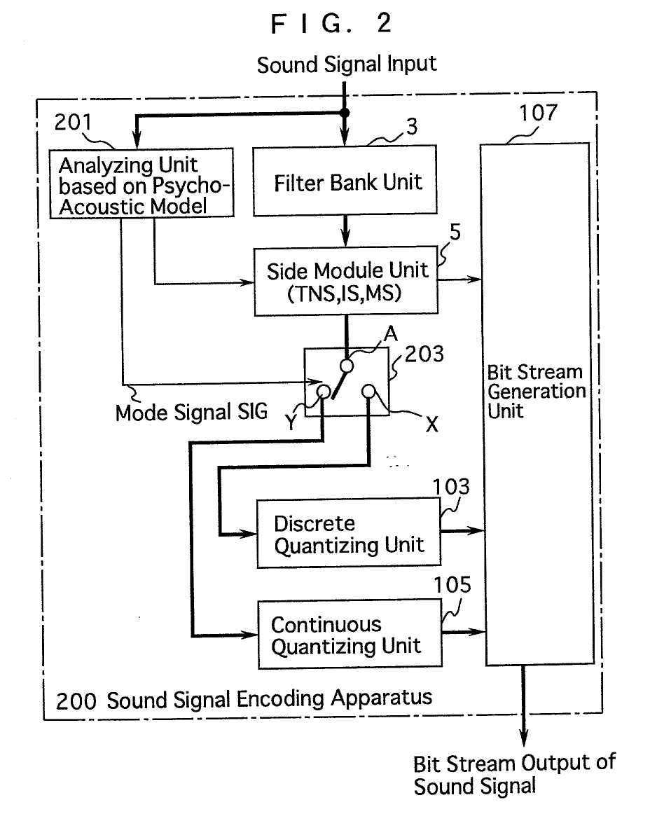

The second embodiment of the sound signal encoding apparatus 200 according to the present invention is shown in FIG. 2 as comprising a psycho-acoustic representation analyzing unit 201, and a switch 203 which are different from and replaced by the psycho-acoustic representation analyzing unit 1 and the quantization mode deciding unit 101, respectively, forming part of the first embodiment of the sound signal encoding apparatus according to the present invention The reaming parts and elements constituting the second embodiment of the sound signal encoding apparatus according to the present invention are entirely the same as those of the first embodiment of the sound signal encoding apparatus according to the present invention. The following description is thus directed mainly to the psycho-acoustic representation analyzing unit 201 and a switch 203 while the reaming parts and elements constituting the second embodiment of the sound signal encoding apparatus will not be described hereinafter.

The psycho-acoustic representation analyzing unit 201 is operative in a first step to analyze the sound signal inputted therein on the basis of the psycho-acoustic model formed with the human's acoustic characteristic, in a second step to calculate a masking level with respect to the sound signal, and in a third step to decide whether one of the pure sound component and non-pure sound component is more than the other of the pure sound component and non-pure sound component. In the present embodiment of the sound signal encoding apparatus according to the present invention, the psycho-acoustic representation analyzing unit 201 is operative in one mode to output a node signal SIG when deciding that the pure component is more than the non-pure component, and in the other mode not to output a mode signal SIG when deciding that the non-pure component is more than the pure component.

The switch 203 has an input terminal A electrically connected to the side module 5, a first output terminal X electrically connected to the discrete quantization unit 103, and a second output terminal Y electrically connected to the continuous quantization unit 105. The switch 203 is operative to output the sound signal inputted therein through one of the first output terminal X and the second output terminal Y selected on the basis of the mode signal SIG from the psycho-acoustic representation analyzing unit 201. The input terminal A is designed to be electrically connected to the first output terminal X when the mode signal SIG is inputted to the switch 203 while the input terminal A is adapted to be electrically connected to the second output terminal Y when the mode signal SIG is not inputted to the switch 203.

The operation of the sound encoding apparatus 200 thus constructed will be described hereinafter.

The sound signal is firstly inputted into the psycho-acoustic representation analyzing unit 201 and the filter bank 3. The psycho-acoustic representation analyzing unit 201 is operative to calculate a making level to be outputted to the side module 5 so that the side module 5 is controlled by the output signal of the psycho-acoustic representation analyzing unit 201. The psycho-acoustic representation analyzing unit 201 is additionally operative to decide whether one of the pure component and non-pure component is more than the other of the pure and non-pure component in the sound signal based on every predetermined frequency of the sound signal. The sound signal inputted into the filter bank 3 is then divided into a plurality of sub-band signal sections based on every predetermined frequency of the sound signal. The divided sub-band signal sections are then inputted into the side module 5 in a similar fashion to the first embodiment of the sound signal encoding apparatus.

The side module 5 is operative to perform various kinds of processing operation to enhance the encoding efficiency of the sound signal encoding apparatus according to the present invention.

The psycho-acoustic representation analyzing unit 201 is operated to decide whether one of the pare component and non-pure component is more than the other of the pure and non-pure component in the sound signal based on every predetermined frequency of the sound signal. When the pure component is decided by the psycho-acoustic representation analyzing unit 201 as being more than the non-pure component in every frequency range of the sound signal, the psycho-acoustic representation analyzing unit 201 is operated to output a mode signal SIG to the discrete quantization unit 103 through the first output terminal X. When, one the other hand, the non-pure component is decided by the psycho-acoustic representation analyzing unit 201 as being more than the pure component in every frequency range of the sound signal, the psycho-acoustic representation analyzing unit 201 is operated not to output a mode signal SIG to the continuous quantization unit 105 through the second output terminal Y.

The discrete quantization unit 103 is in principle operated to quantize only the pure component in the inputted sound signal while the continuous quantization unit 105 is operated to quantize not only the pure component but also the non-pure component assigned with a quantization bit needed at a minimum level. The quantized signal by the discrete quantization unit 103 and the continuous quantization unit 105 is outputted into the bit so generating unit 107. The outputted signals from the side module 5, the discrete quantization unit 103 and the continuous quantization unit 105 cause the bit stream generation unit 107 to generate a bit stream by trimming the output signals from the side module 5, the discrete quantization unit 103 and the continuous quantization unit 105.

From the above detailed description, it will be understood that the sound signal can be encoded at a relatively high quality without being affected by the pure component and non-pure component of the sound signal in a similar fashion to the first embodiment of the sound signal encoding apparatus by the reason that the second embodiment of the audio signal encoding apparatus 200 according to the present invention comprises a psycho-acoustic representation analyzing unit 201 for deciding whether or not one of the pure sound component and non-pure sound component is more than the other of the pure sound component and non-pure sound component, a switch 203 for changing into the mode optimum to quantize the sound signal, and a discrete quantization unit 103 and a continuous quantization unit 105 both of which are operative to quantize the sound signal under its optimum state based on the decision of the psycho-acoustic representation analyzing unit 201.

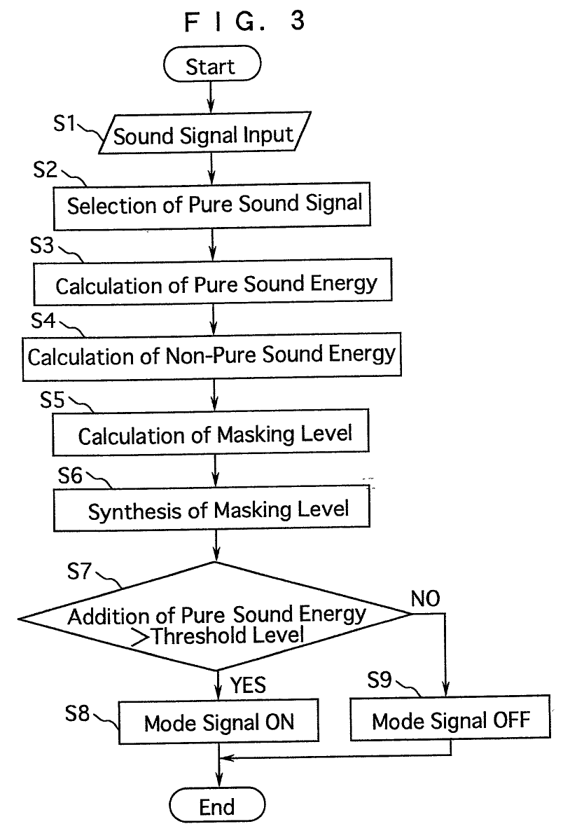

FIG. 3 shows a flow chart representative of first example for the process of the psycho-acoustic representation analyzing unit 201 forming part of the third embodiment of the audio signal encoding apparatus 200 according to the present invention as shown in FIG. 2. The process of the psycho-acoustic representation analyzing unit 201 is recorded by a recodable media under a predetermined program set forth by a special language and capable of being read and executed by a computer. The program is executed by the computer to realize the press of the psycho-acoustic representation analyzing unit 201 forming part of the audio signal encoding apparatus 200 according to the present invention.

In step S1, the sound signal is initially inputted into the psycho-acoustic representation analyzing unit 201 and the filter bank 3. In step S2, the pure component is then selected from the sound signal. From the pure component thus selected is then calculated an energy in step S3 while an energy corresponding to the non-pure component other than the pure component is calculated in step S4. The calculations to the pure component and the non-pure component are then made in step S5 and subsequently synthesized in step S6.

The decision is then made in step S7 about whether or not the addition of the energy values to the pure component exceeds a predetermined threshold level. When the addition of the energy values to the pure component exceeds a predetermined threshold level, it is decided that the pure component is more than the non-pure component in the sound signal, thereby causing the mode signal SIG to be outputted in step S8. When, one the other hand, the addition of the energy values to the pure component does not exceed a predetermined threshold level, it is decided that the non-pure component is more than the pure component in the sound signal, thereby causing the mode signal SIG not to be outputted in step S8.

The operation of the third embodiment of the sound signal encoding apparatus according to the present invention will be described hereinafter with reference to FIGS. 2 and 3.

The psycho-acoustic representation analyzing unit 201 is operated in compliance with the process shown by a flowchart in FIG. 3. The psycho-acoustic representation analyzing unit 201 has a sound signal inputted therein in step S1 and is then operated to analyze the sound signal in the predetermined process in steps S2 to S6 before deciding whether or not the addition of the energy values to the pure component exceeds the predetermined threshold value in step S7.

When the addition of the energy values to the pure component exceeds the predetermined threshold level in step S7, the process advances to step S8 having the mode signal SIG to be outputted to the switch 203. When the mode signal SIG is inputted to the switch 203, the switch 203 is operated to have the filter bank 3 connected through the side module 5 to the discrete quantization unit 103 in which only the pure component in the sound signal is quantized.

When, on the other hand, the addition of the energy values to the pure component does not exceed the predetermined threshold level in step S7, the process advances to step S9 having the mode signal SIG not to be outputted to the switch 203. When the mode signal SIG is not inputted to the switch 203, the switch 203 is operated to have the filter bank 3 connected through the side module 5 to the continuous quantization unit 105 in which not only the pure component in the sound signal but also the non-pure component forcibly assigned with a quantization bit is quantized.

From the above detailed description, it will be understood that the sound signal can be encoded at a relatively high quality without being affected by the pure component and non-pure component of the sound signal in a similar fashion to the previously mentioned embodiments of the sound signal encoding apparatus by the reason that the third embodiment of the sound signal encoding apparatus 200 according to the present invention comprises a psycho-acoustic representation analyzing unit 201 for deciding whether one of the pure sound component and non-pure sound component is more than the other of the pure sound component and non-pure sound component, a switch 203 for changing into the mode optimum to quantize the sound signal, and a discrete quantization unit 103 and a continuous quantization unit 105 both of which are controlled by the psycho-acoustic representation analyzing unit 201 to quantize the sound signal under its optimum state based on the decision of the psycho-acoustic representation analyzing unit 201.

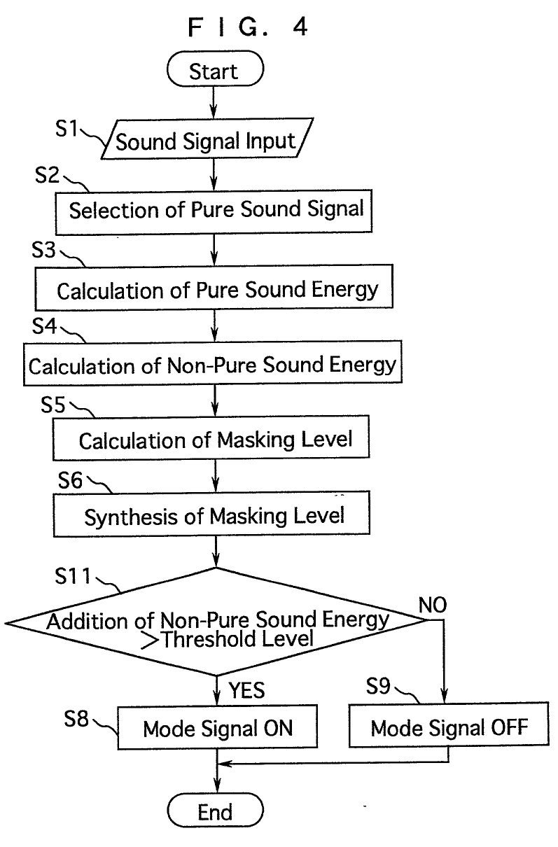

FIG. 4 shows the second example of a flow chart representative of the process of the psycho-acoustic representation analyzing unit 201 forming part of the forth embodiment of the sound signal encoding apparatus 200 according to the present invention as shown in FIG. 2. The process of the psycho-acoustic representation analyzing unit 201 is recorded by a recording media under a predetermined program set forth by a special language and capable of being read and executed by a computer. The program is executed by the computer to realize the process of the process of the psycho-acoustic representation analyzing unit 201.

The forth embodiment of the sound signal encoding apparatus 200 according to the present invention is shown in FIG. 3 as comprising step 7 which are different from and replaced by step 11.

The decision is then made in step S11 about whether or not the addition of the energy values to the non-pure component does not exceeds a predetermined threshold level. When the addition of the energy values to the non-pure component does not exceeds a predetermined threshold level, it is decided that the pure component is more than the non-pure component in the sold signal, thereby causing the mode signal SIG to be outputted in step S8. When, one the other hand, the addition of the energy values to the pure component does not exceed a predetermined threshold level, it is decided that the non-pure component is more than the pure component in the sound signal, thereby causing the mode signal SIG not to be outputted in step S9.

The operation of the forth embodiment of the sound signal encoding apparatus according to the present invention will be described hereinafter with reference to FIGS. 2 and 4.

The psycho-acoustic representation analyzing unit 201 is operated in compliance with the process represented by a flowchart in FIG. 4. The psycho-acoustic representation analyzing At 201 has a sound signal inputted therein in step S1 and is then operated to analyze the sound signal in the predetermined process in steps S2 to S6 before deciding whether or not the total of the energy values to the pure component exceeds the predetermined threshold value in step S11.

When the addition of the enemy values to the non-pure component does not exceed the predetermined threshold level in step S11, the process advances to step S8 having the mode signal SIG to be outputted to the switch 203. When the mode signal SIG is inputted to the switch 203, the switch 203 is operated to have the filter bank 3 connected through the side module 5 to the discrete quantization unit 103 in which only the pure component in the sound signal is quantized.

When, on the other hand, the addition of the energy values to the pure component does not exceed the predetermined threshold level in step S11, the process advances to step S9 having the mode signal SIG not to be outputted to the switch 203, When the mode signal SIG is not inputted to the switch 203, the switch 203 is operated to have the filter bank 3 connected through the side module 5 to the continuous quantization unit 105 in which not only the pure component in the sound signal but also the non-pure component forcibly assigned with a quantization bit is quantized.

From the above detailed description, it will be understood that the sound signal can be encoded at a relatively high quality without being affected by the pure component and non-pure component of the sound signal in a similar fashion to the previously mentioned embodiments of the sound signal encoding apparatus by the reason that the forth embodiment of the sound signal encoding apparatus 200 according to the present invention comprises a psycho-acoustic representation analyzing unit 201 for deciding whether one of the pure sound component and non-pure sound component is more than the other of the pure sound component and non-pure sound component, a switch 203 for changing into the mode optimum to quantize the sound signal, and a discrete quantization unit 103 and a continuous quantization unit 105 both of which are controlled by the psycho-acoustic representation analyzing unit 201 to quantize the sound signal under its optimum state based on the decision of the psycho-acoustic representation analyzing unit 201.

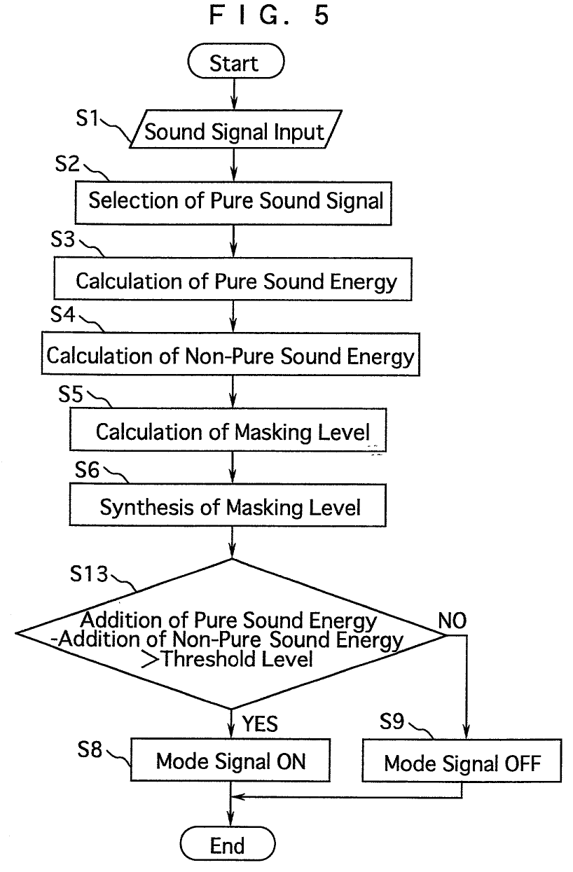

FIG. 5 shows the third example of a flow chart representative of the process of the psycho-acoustic representation analyzing unit 201 forming part of the forth embodiment of the sound signal encoding apparatus 200 according to the present invention as shown in FIG. 2. The process of the psycho-acoustic representation analyzing unit 201 is recorded by a recording media under a predetermined program set forth by a special language and capable of being read and executed by a computer. The program is executed by the computer to realize the process of the process of the psycho-acoustic representation analyzing unit 201.

The fifth embodiment of the sound signal encoding apparatus 200 according to the present invention is shown in FIG. 3 as comprising step 7 which arc different from and replaced by step 13.

The decision is then made in step S11 about whether or not the addition of the energy values to the non-pure component does not exceeds a predetermined threshold level. When the addition of the energy values to the non-pure component does not exceeds a predetermined threshold level, it is decided that the pure component is more than the non-pure component in the sound signal, thereby causing the mode signal SIG to be outputted in step S8. When, one the other hand, the addition of the energy values to the pure component does not exceed a predetermined threshold level, it is decided that the non-pure component is more than the pure component in the sound signal, thereby causing the mode signal SIG not to be outputted in step S9.

The operation of the fifth embodiment of the sound signal encoding apparatus according to the present invention will be described hereinafter with reference to FIGS. 2 and 5.

The psycho-acoustic representation analyzing unit 201 is operated in compliance with the process shown by a flowchart in FIG. 5. The psycho-acoustic representation analyzing unit 201 has a sound signal inputted therein in step S1 and is then operated to analyze the sound signal in the predetermined process in steps S2 to S6 before deciding whether or not the difference between the addition of the energy values to the pure component and the addition of the energy values to the non-pare component exceeds the predetermined threshold value in step S13.

When the difference between the addition of the energy values to the pure component and the addition of the energy values to the non-pure component exceeds the predetermined threshold level in step $13, the process advances to step S8 having the mode signal SIG to be outputted to the switch 203. When the mode signal SIG is inputted to the switch 203, the switch 203 is operated to have the filter bank 3 connected through the side module 5 to the discrete quantization unit 103 in which only the pure component in the sound signal is quantized.

When, on the other hand, the difference between the addition of the energy values to the pure component and the addition of the energy values to the non-pure component does not exceed the predetermined threshold level in step S13, the process advances to step S9 having the mode signal SIG not to be outputted to the switch 203. When the mode signal SIG is not inputted to the switch 203, the switch 203 is operated to have the filter bank 3 connected through the side module 5 to the continuous quantization unit 105 in which not only the pure component in the sound signal but also the non-pure component forcibly assigned with a quantization bit is quantized.

From the above detailed description, it will be understood that the sound signal can be encoded at a relatively high quality without being affected by the pure component and non-pure component of the sound signal in a similar fashion to the previously mentioned embodiments of the sound signal encoding apparatus by the reason that the fifth embodiment of the sound signal encoding apparatus 200 according to the present invention comprises a psycho-acoustic representation analyzing At 201 for deciding whether one of the pure sound component and non-pure sound component is more than the other of the pure sound component and non-pure sound component, a switch 203 for changing into the mode optimum to quantize the sound signal, and a discrete quantization unit 103 and a continuous quantization unit 105 both of which are controlled by the psycho-acoustic representation analyzing unit 201 to quantize the sound signal under its optimum state based on the decision of the psycho-acoustic representation analyzing unit 201.

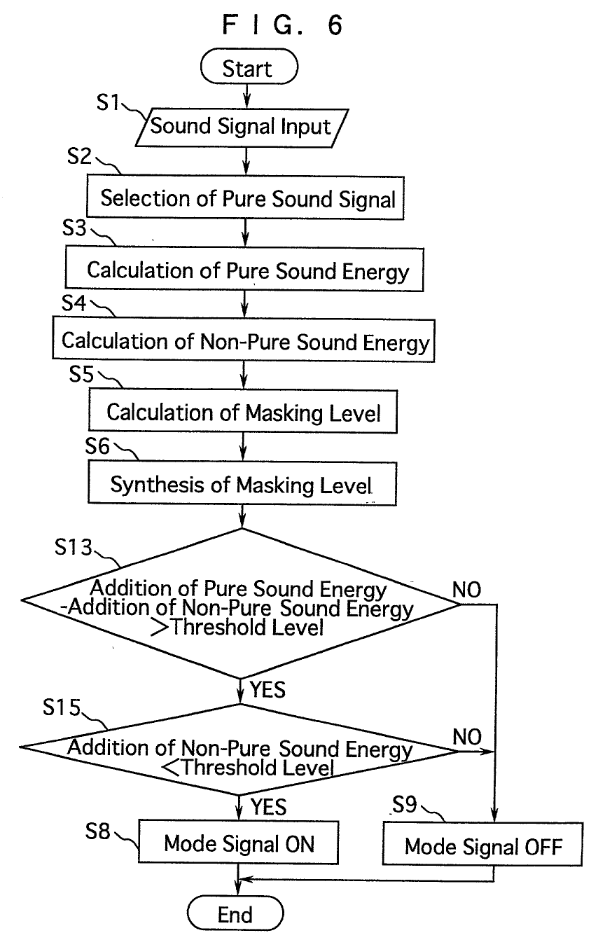

FIG. 6 shows the fifth example of a flow chart representative of the process of the psycho-acoustic representation analyzing unit 201 forming part of the forth embodiment of the sound signal encoding apparatus 200 according to the present invention as shown in FIG. 2. The process of the psycho-acoustic representation analyzing unit 201 is recorded by a recording media under a predetermined program set forth by a special language and capable of being read and executed by a computer. The program is executed by the computer to realize the process of the process of the psycho-acoustic representation analyzing unit 201.

The fifth embodiment of the sound signal encoding apparats 200 according to the present invention is shown in FIG. 5 as comprising step 15 which are different from and replaced by step 13.

When the difference between the addition of the energy values to the pure component and the addition of the energy values to the non-pure component exceeds the predetermined threshold level in step S13, the process advances to step S15 having the mode signal SIG. When, on the other band, the addition of the energy values to the non-pure component exceeds the predetermined threshold level in step S13, the process advances to step S15 having the mode signal SIG.

When, that is, difference between the addition of the energy values to the pure component and the addition of the energy values to the non-pure component exceeds the predetermined threshold level in step S13, and the addition of the energy of non-pure element does not exceed the predetermined threshold level in step S13, the inputted sound signal contains the energy values to the pure-sound element more than the other.

The operation of the fifth embodiment of the sound signal encoding apparatus according to the present invention will be described hereinafter with reference to FIGS. 2 and 6.

The psycho-acoustic representation analyzing unit 201 is operated in compliance with the process shown by a flowchart in FIG. 4. The psycho-acoustic representation analyzing unit 201 has a sound signal inputted therein in step S1 and is then operated to analyze the sound signal in the predetermined process in steps S2 to S6 before deciding whether or not the addition of die energy values to the pure component exceeds the predetermined threshold value in step S13.

The psycho-acoustic representation analyzing unit 201 is operated in compliance with the process shown by a flowchart in FIG. 6. The psycho-acoustic representation analyzing unit 201 has a sound signal inputted therein in step S1 and is then operated to analyze the sound signal in the predetermined process in steps S2 to S6 before deciding whether or not the difference between the addition of the energy values to the pure component and the addition of the energy values to the non-pure component exceeds the predetermined threshold value in step S13.

When the difference between the addition of the energy values to the pure component and the addition of the energy values to the non-pure component exceeds the predetermined threshold level in step S7, the process advances to step S8 having the mode signal SIG to be outputted to the switch 203. When the mode signal SIG is inputted to the switch 203, the switch 203 is operated to have the filter bank 3 connected through the side module 5 to the discrete quantization unit 103 in which only the pure component in the sound signal is quantized.

When, on the other hand, the addition of the energy values to the pure component does not exceed the predetermined threshold level in step S15, the process advances to step S9 having the mode signal SIG not to be outputted to the switch 203, When the mode signal SIG is not inputted to the switch 203, the switch 203 is operated to have the filter bank 3 connected though the side module 5 to the continuous quantization unit 105 in which not only the pure component in the sound signal but also the non-pure component forcibly assigned with a quantization bit is quantized.

When, furthermore, the addition of the energy values to the pure component exceeds the predetermined threshold level in step S15, the process advances to step S9 having the mode signal SIG not to be outputted to the switch 203. When the mode signal SIG is not inputted to the switch 203, the switch 203 is operated to have the filter bank 3 connected through the side module 5 to the continuous quantization unit 105 in which not only the pure component in the sound signal but also the non-pure component forcibly assigned with a quantization bit is quantized.

From the above detailed description, it will be understood that the sound signal can be encoded at a relatively high quality without being affected by the pure component and non-pure component of the sound signal in a similar fashion to the previously mentioned embodiments of the sound signal encoding apparatus by the reason that the sixth embodiment of the sound signal encoding apparatus 200 according to the present invention comprises a psycho-acoustic representation analyzing unit 201 for deciding whether one of the pure sound component and non-pure sound component is more than the other of the pure sound component and non-pure sound component, a switch 203 for changing into the mode optimum to quantize the sound signal, and a discrete quantization unit 103 and a continuous quantization unit 105 both of which are controlled by the psycho-acoustic representation analyzing unit 201 to quantize the sound signal under its optimum state based on the decision of the psycho-acoustic representation analyzing unit 201.

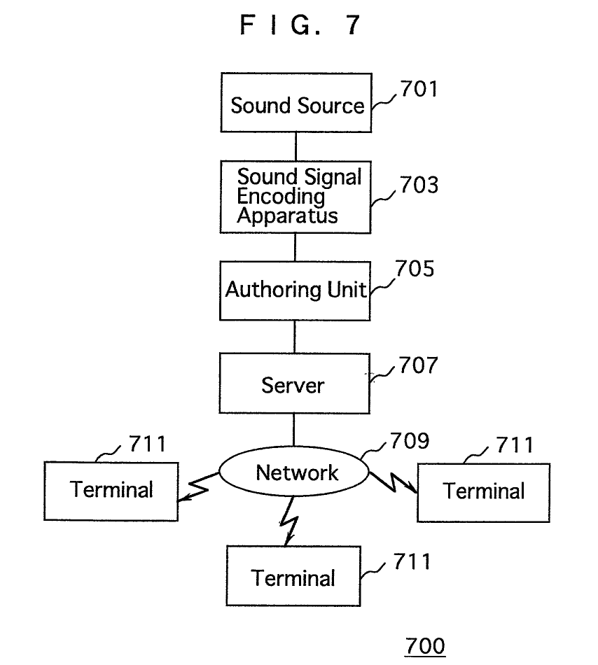

FIG. 7 shows a block diagram representative of the general construction of a music delivery system having a sound encoding system as the seventh example of the present invention. The music delivery system 700 comprises a sound signal encoding system 703 electrically connected to a sound source, an authoring apparatus 705 electrically connected to a music sound encoding apparatus 703, a saver electrically connected to an authoring apparat 705 And at least a terminal unit 711 electrically connected to a server through a network 709.

The music signal encoding apparatus 703 is operative to generate and output a bit stream signal after encoding a sound signal inputted therein from the sound source 701. The authoring apparatus is designed to receive the encoded bit stream signal to output the bit stream after being compiled and coded. The compiled and coded signal from the authoring apparatus is inputted into and accumulated by the delivery server 707. The delivery server 707 is operative to deliver the compiled and coded bit stream to a plurality of terminals through a network when the bit stream is requested to be delivered. The network 709 includes an internet, a wireless communication system and the like. The terminals 711 are operative to receive the bit stream through the network 709 and to have the bit stream decoded to reproduce the sound signal.

From the foregoing description, it will be understood that the music delivery system 700 according to present invention thus constructed as previously mentioned can perform the optimum quantization of the sound signal irrespective of tie ratio of the pure sound component and the non-pure component contained therein. As means that the sound signal can be encoded at a relatively high quality without being affected by the pure component and non-pure component of the sound.

Also, the sound signal coding apparatus according to the present invention thus constructed as previously mentioned can perform the optimum quantization of die sound signal irrespective of the ratio of the pure sound component and the non-pure component contained therein. This means that the sound signal can be encoded at a relatively high quality without being affected by the pure component and non-pure component of the sound and what is more the music encoding system according to present invention thus constructed as previously mentioned can be encoded at a relatively high quality without being affected by the pure component and non-pure component of the sound.

While the subject invention has been described with relation to the preferred embodiments, various modifications and adaptations thereof will now be apparent to those skilled in the art as far as such modifications and adaptations fall within the scope of the appended claims intended to be covered thereby.

What is claimed is:

1. A sound signal encoding apparatus, comprising:
sampling means for dividing and sampling a signal inputted therein into a plurality of sound signal sections based on the frequency ranges of said sound signal; each of said sound sections having a pure sound component and a non-pure sound component, and
encoding means for encoding said sound signal sections after quantizing said sound signal sections divided and sampled based on the frequency ranges of said sound signal,
said encoding means comprising
a deciding unit for deciding which one in said pure sound component and non-pure sound component is more than the other of said pure sound component and non-pure sound component with respect to each of said sound signal sections divided and sampled based on the frequency ranges of said sound signal;
a first quantizing unit for quantizing only said pure sound component at a first quantization level when said deciding unit is operated to decide that said pure sound component is more than said non-pure sound component with respect to each of said sound signal sections divided and sampled based on the frequency ranges of said sound signal; and
a second quantizing unit for quantizing both said pure sound component and said non-pure sound component by way of the predetermined bits of data allocated to both said pure sound component and said non-pure sound component when said deciding unit is operated to decide that said non-pure sound component is more than said pure sound component with respect to each of said sound signal sections divided and sampled based on the frequency ranges of said sound signal sampled based on the frequency ranges of said sound signal.

2. A sound signal cording apparatus as set forth in claim 1 which further comprises analyzing means for analyzing said sound signal inputted into said sampling means based on the psycho-acoustic model of human hearing characteristics, said deciding means being operative to decide on the basis of the results analyzed by said analyzing means about which one in said pure sound component and non-pure sound component is more than the other of said pure sound component and non-pure sound component with respect to each of said sound signal sections divided and sampled based on the frequency ranges of said sound signal.

3. A sound signal cording apparatus as set forth in claim 2 in which said analyzing means is operative to calculate the absolute amount of energy of said pure sound component before analyzing said sound signal inputted into said sampling means based on said absolute amount of energy of said pure sound component.

4. A sound signal cording apparatus as set forth in claim 2 in which said analyzing means is operative to calculate the absolute amount of energy of said non-pure sound component before analyzing said sound signal inputted into said sampling means based on said absolute amount of energy of said non-pure sound component.

5. A sound signal cording apparatus as set forth in claim 2 in which said analyzing means is operative to calculate a difference between the absolute amount of energy of said pare sound component and the absolute amount of energy of said non-pure sound component before analyzing said sound signal inputted into said sampling means based on said difference between the absolute amount of energy of said pure sound component and the absolute amount of energy of said non-pure sound component.

6. A sound signal cording apparatus as set forth in claim 2 in which said analyzing means is operative to calculate the absolute amount of energy of said non-pure sound component and a difference between the absolute amount of energy of said pure sound component and the absolute amount of energy of said non-pure sound component before analyzing said sound signal inputted into said sampling means based on said absolute amount of energy of said non-pure sound component and said difference between the absolute amount of energy of said pure sound component and the absolute amount of energy of said non-pure sound component.

7. A sound signal delivery system, comprises: a sound signal encoding apparatus as set forth in claims 1 to 6, a server unit for accumulating the sound signals coded by the sound signal coding apparatus, a plurality of terminal units for requesting said sound signals coded by the sound signal coding apparatus, and a network between said server unit and said terminal units to have said server unit and said terminal units electrically connected to each other, said sever unit being operative to deliver said sound signals coded by the sound signal coding apparatus to said terminal units trough said network when said terminal units are operative to request said sever unit to deliver said sound signals coded by the sound signal coding apparatus to said terminal units.

8. A sound signal encoding method, comprising:
sampling step of dividing and sampling a signal inputted into a plurality of sound signal sections based on the frequency ranges of said sound signal; each of said sound sections having a pure sound component and a non-pure sound component, and
encoding step of encoding said sound signal sections after quantizing said sound signal sections divided and sampled based on the frequency ranges of said sound signal,
said encoding step comprising:
a deciding step of deciding which one in said pure sound component and non-pure sound component is more than the other of said pare sound component and non-pure sound component with respect to each of said sound signal sections divided and sampled based on the frequency ranges of said sound signal;
a first quantizing step of quantizing only said pure sound component at a first quantization level when said deciding unit is operated to decide that said pure sound component is more than said non-pure sound component with respect to each of said sound signal sections divided and sampled based on the frequency ranges of said sound signal; and
a second quantizing step of quantizing both said pure sound component and said non-pure sound component by way of the predetermined bits of data allocated to both said pure sound component and said non-pure sound component when said deciding unit is operated to decide that said non-pure sound component is more than said pure sound component with respect to each of said sound signal sections divided and sampled based on the frequency ages of said sound signal sampled based on the frequency ranges of said sound signal.

9. A sound signal cording method as set forth in claim 8 which farther comprises an analyzing step of analyzing said sound signal inputted in said sampling step based on the psycho-acoustic model of human auditory organs characteristics, said deciding step being to decide on the basis of the results analyzed in said analyzing step about which one in said pure sound component and non-pure sound component is more than the other of said pure sound component and non-pure sound component with respect to each of said sound signal sections divided and sampled based on the frequency ranges of said sound signal.

10. A sound signal cording method as set forth in claim 9 in which said analyzing step is of calculating the absolute amount of energy of said pure sound component before analyzing said sound signal inputted in said sampling step based on said absolute amount of energy of said pure sound component.

11. A sound signal cording method as set forth in claim 9 in which said analyzing step is of calculating the absolute amount of energy of said non-pure sound component before analyzing said sound signal inputted in said sampling step based on said absolute amount of energy of said non-pure sound component.

12. A sound signal cording method as set forth in claim 9 in which said analyzing step is of calculating a difference between the absolute amount of energy of said pure sound component and the absolute amount of energy of said non-pure sound component before analyzing said sound signal inputted in said sampling step based on said difference between the absolute amount of energy of said pure sound component and the absolute amount of energy of said non-pure sound component.

13. A sound signal cording method as set forth in claim 9 in which said analyzing step is of calculating the absolute amount of energy of said non-pure sound component and a difference between the absolute amount of energy of said pure sound component and the absolute amount of energy of said non-pure sound component before analyzing said sound signal inputted in said sampling step based on said absolute amount of energy of said non-pure sound component and said difference between the absolute amount of energy of said pure sound component and the absolute amount of energy of said non-pure sound component.

14. A recodable media having a sound signal encoding program recorded therein and capable of being recorded by computers, said sound signal encoding program comprises:
sampling step of dividing and sampling a signal inputted in a plurality of sound signal sections based on the frequency ranges of said sound signal; each of said sound sections having a pure sound component and a non-pure sound component, and encoding step of encoding said sound signal sections after quantizing said sound signal sections divided and sampled based on the frequency ranges of said sound signal,
said encoding step comprising:
a deciding step of deciding which one in said pure sound component and non-pure sound component is more than the other of said pure sound component and non-pure sound component with respect to each of said sound signal sections divided and sampled based on the frequency ranges of said sound signal;
a first quantizing step of quantizing only said pure sound component at a first quantization level when said deciding unit is operated to decide that said pure sound component is more than said non-pure sound component wit respect to each of said sound signal sections divided and sampled based on the frequency ranges of said sound signal; and
a second quantizing step of quantizing both said pare sound component and said non-pure sound component by way of the predetermined bits of data allocated to both said pure sound component and said non-pure sound component when said deciding unit is operated to decide that said non-pure sound component is more than said pure sound component with respect to each of said sound signal sections divided and sampled based on the frequency ranges of said sound signal sampled based on the frequency ranges of said sound signal.

15. A recodable media hang a sound signal encoding program recorded therein as set forth in claim 14, which further comprises an analyzing step of analyzing said sound signal inputted in said sampling step based on the psycho-acoustic model of human auditory organs characteristics, said deciding step being to decide on the basis of the results analyzed in said analyzing step about which one in said pure sound component and non-pure sound component is more than the other of said pure sound component and non-pure sound component with respect to each of said sound signal sections divided and sampled based on the frequency ranges of said sound signal.

16. A recodable media having a sound signal encoding program recorded therein as set forth in claim 15, in which said analyzing step is of calculating the absolute amount of energy of said pure sound component before analyzing said sound signal inputted in said sampling step based on said absolute amount of energy of said pare sound component.

17. A recodable media having a sound signal encoding program Corded therein as set forth in claim 15, in which said analyzing step is of calculating the absolute amount of energy of said non-pure sound component before analyzing said sound signal inputted in said sampling step based on said absolute amount of energy of said non-pure sound component.

18. A recodable media having a sound signal encoding program recorded therein as set forth in claim 15, in which said analyzing step is of calculating a difference between the absolute amount of energy of said pure sound component and the absolute amount of energy of said non-pure sound component before analyzing said sound signal inputted in said sampling step based on said difference between the absolute amount of energy of said pure sound component and the absolute amount of energy of said non-pure sound component.

19. A recodable media having a sound signal encoding program recorded therein as set forth in claim 15, in which said analyzing step is of calculating the absolute amount of energy of said non-pure sound component and a difference between the absolute amount of energy of said pure sound component and the absolute amount of energy of said non-pure sound component before analyzing said sound signal inputted in said sampling step based on said absolute amount of energy of said non-pure sound component and said difference between the absolute amount of energy of said pure sound component and the absolute amount of energy of said non-pure sound component.
